(19) United States
(12) Patent Application Publication
(10) Pub. No.: US 2011/0210029 A1
(43) Pub. Date: Sep. 1, 2011

(54) DECORATIVE PROPANE TANK ASSEMBLY

(76) Inventors: Jason Ontjes, Nickerson, KS (US); Joel Alderson, Andover, KS (US)

(21) Appl. No.: 12/757,643

(22) Filed: Apr. 9, 2010

Related U.S. Application Data
(63) Continuation-in-part of application No. 12/714,672, filed on Mar. 1, 2010.

(51) Int. Cl. B65D 25/20; F17C 1/00

(52) U.S. Cl. 206/457; 220/23.91; 220/694; 220/581

(57) ABSTRACT

Three-dimensional, sports-related cover assemblies (34, 84, 94, 108, 126, 144) for propane tanks (32) are provided in order to permit sport- or team-related decoration of the tanks (32). The cover assemblies (34, 84, 94, 108, 126, 144) may be separable from the tanks (32) or may be integrated and unitized with the tanks (32). The assemblies (34, 84, 94, 108, 126, 144) have substantially rigid, contoured or concavo-convex outer walls presenting surfaces (70, 86, 104, 112, 130, 150), which are configured to give the three-dimensional likeness or appearance of a sports-related item, such as athletic head gear, footwear, balls, or other equipment.

### CROSS-REFERENCE TO RELATED APPLICATION

This is a continuation-in-part of identically titled application Ser. No. 12/714,672, filed Mar. 1, 2010.

### BACKGROUND OF THE INVENTION

1. Field of the Invention

The present invention is broadly concerned with decorative cover assemblies designed to cover a propane tank (e.g., a standard 20 lb. household tank) and to present the three-dimensional appearance or likeness of a sports-related item, such as athletic headgear or athletic balls. More specifically, the invention is directed to such cover assemblies which may be separate from a propane tank or integrated therewith, and which may be formed of any suitable material, such as metal or synthetic resin. Exemplary cover assemblies in accordance with the invention may be solid, hollow, or inflatable.

2. Description of the Prior Art

A tailgate party is a social event held on or around the open tailgates of vehicles. Tailgating traditionally involves consuming beverages and grilling food. Tailgate parties often occur in the parking lots of stadiums and arenas before, during, and after sporting events. For example, tailgate parties have become particularly popular in the U.S. as social gatherings that take place in stadium parking lots before football games. As an adjunct to such parties, tailgaters have flags, pennants, outerwear such as shirts, jackets, and caps, and all manner of other items, bearing the logo and/or name of their favorite team. Such team identification is deemed essential by tailgate participants.

Dedicated tailgaters sometimes have elaborate portable equipment for grilling of foods. Thus, many tailgaters have portable propane grills making use of one or more standard household propane tanks. These tanks are generally white in color and are positioned beneath the grill. As such, the tanks are unsightly and do not contribute to the festive atmosphere of a tailgate party. Various covers have been provided in the past for coolers and barbecue grills.

Additionally, flexible cloth-type covers for propane tanks have been proposed, which do not provide a definite, three-dimensional shape. See U.S. Pat. Nos. 4,705,085, 5,622,261, 6,237,787, 6,386,384, 6,401,951, and 6,866,159; U.S. Design Pat. Nos. D289,598, D351,971, D442,818, D486,551, D516,365, D572,478, D577,096, D577,097, D577,791, and D599,625; U.S. Published Patent Applications Nos. 2002/0175193, 2005/0205180, and 2007/0068957; Foreign Patent Publications Nos. AU2009100673 and GB2441056; and non-patent literature items entitled Baseball Jersey Grill Cover, BBQ Covers-Mustard Bottle, and Propane Tanks Cover.

It would therefore be a boon to tailgaters if unattractive and innocuous propane tanks could be decorated in a manner consistent with a tailgate party scheme, and particularly to give the appearance or likeness of a sports-related item consistent with the tailgate party theme.

### SUMMARY OF THE INVENTION

The present invention addresses the problem outlined above, and provides decorated propane tanks with sports-related themes. In some embodiments, cover assemblies for propane tanks are provided, each comprising a decorative body having wall structure designed to surround a propane tank with a substantially rigid outer wall configured to present a three-dimensional likeness or appearance of a sports-related item. The wall structure may also include an inner wall designed to mate with a propane tank (i.e., the inner wall is configured to rest upon or otherwise be supported by a propane tank wall). The cover assembly may be separable from a propane tank, can be integrated with the tank, or the tank may be formed with the decorative surface aspects, such that there is no separate tank. The outer surface of the cover assembly is typically designed to give the three-dimensional likeness or appearance of things such as athletic headgear, athletic footwear, athletic balls, or other athletic equipment.

As noted, the cover assemblies have substantially rigid outer walls defining the corresponding sports-related item, and preferably the entirety of the decorative bodies are of substantially rigid construction. The bodies have upper margins below the valve associated with the propane tank. In this fashion, the valve may be connected to a barbecue grill, for example, without interference by the cover assemblies. Thus, the propane tank can be used in the usual fashion with the cover assemblies of the invention in place. Moreover, the cover assemblies of the invention are not inflatable, as in the case of certain prior art covers; it is believed that such inflatable designs would not provide the degree of verisimilitude that can be achieved with the substantially rigid designs of the invention.

As used herein, with reference to the cover assembly bodies of the invention “three-dimensional” means that a given cover assembly body presents a contoured or concavo-convex outer surface, preferably with portions of the outer surface spaced a significant distance (preferably at least about one-half inch, and most preferably at least about one inch) from the proximal propane tank wall. Such three-dimensional cover assemblies thus are distinctly different from conventional two-dimensional images printed on a simple flexible tank cover or the like.

Hence, in the case of a cover assembly body having a simulated athletic headgear outer surface, the headgear is broadly selected from the group consisting of athletic helmets, caps, and hats, e.g., helmets for racing, football, lacrosse, baseball batting, rodeo, fencing, skiing and other winter sports, bicycling, hockey, and boxing. In the case of athletic footwear, the cover assembly body may present the three-dimensional appearance of footwear for soccer, football, hockey, basketball, track, skiing, boxing, golf, ballet, and bicycling. A wide variety of athletic cover assembly bodies may give the three-dimensional appearance of a simulated athletic ball, for example balls selected from the group consisting of baseballs, basketballs, cricket balls, tennis balls, footballs, rugby balls, lacrosse balls, baoding balls, billiard balls, table tennis balls, bowling balls, handballs, soccer balls, wiffle balls, polo balls, golf balls, racquet balls, beach balls, and volley balls. Other cover assembly bodies giving the three-dimensional appearance of simulated sports-related items may include covers giving the three-dimensional appearance of athletic apparel selected from the group consisting of jerseys, shirts, jackets, shorts, pants, stockings, pads, and gloves, hockey pucks, curling stones, racquets, mallets, baseball bats, hockey sticks, and basketball nets. In short, the scope of the present invention is limited only by the imagination of the fabricator.

It will also be appreciated that, in most instances, the outer surface of a given cover assembly would also include the name and/or logo of a specific team or athlete. In this way, the user can both decorate an otherwise bland-looking propane tank, while also proclaiming loyalty to the user's favorite team or athlete.

### BRIEF DESCRIPTION OF THE DRAWINGS

FIG. 1 is a front perspective view of the combination of a standard household propane tank with a detachable, dual section cover assembly in accordance with the invention and presenting the likeness of an automobile racing helmet, wherein the cover assembly is mounted on the tank;

FIG. 2 is a rear perspective view similar to that of FIG. 1, but illustrating the surface structure of the cover assembly opposite that of FIG. 1;

FIG. 3 is a plan view of the combination depicted in FIG. 1;

FIG. 4 is a partial sectional view of the combination depicted in FIG. 1;

FIG. 5 is an exploded view of the combination of FIG. 1, illustrating the cover assembly in its open configuration before being mounted on to the propane tank;

FIG. 6 is a front perspective view of an integrated propane tank and cover assembly in accordance with the invention, the cover assembly presenting the likeness of a football helmet;

FIG. 7 is an elevational view of the assembly of FIG. 6;

FIG. 8 is a rear perspective view of the assembly of FIG. 6;

FIG. 9 is a plan view of the assembly of FIG. 6;

FIG. 10 is front perspective view of a combination comprising a standard household propane tank with a unitary, one-piece cover assembly in accordance with the invention releasably mounted on the tank, the cover assembly presenting the likeness of a racing helmet;

FIG. 11 is an elevational view of the combination illustrated in FIG. 10;

FIG. 12 is a partial sectional view of the combination illustrated in FIG. 10;

FIG. 13 is a vertical sectional view of the one-piece cover assembly separate from the tank;

FIG. 14 is a front perspective view of the combination comprising a standard household propane tank with a hollow molded cover assembly in accordance with the invention mounted on the tank, with the cover assembly presenting the likeness of a football helmet;

FIG. 15 is an elevational view of the combination illustrated in FIG. 14;

FIG. 16 is partial sectional view of the combination of FIG. 14;

FIG. 17 is a vertical sectional view of the hollow molded cover assembly of FIG. 14, shown separate from the tank; and

FIG. 18 is a perspective view of a combination comprising a standard household propane tank with a cover assembly in accordance with the invention mounted on the tank, the cover assembly presenting the likeness of a basketball.

### DETAILED DESCRIPTION OF THE PREFERRED EMBODIMENTS

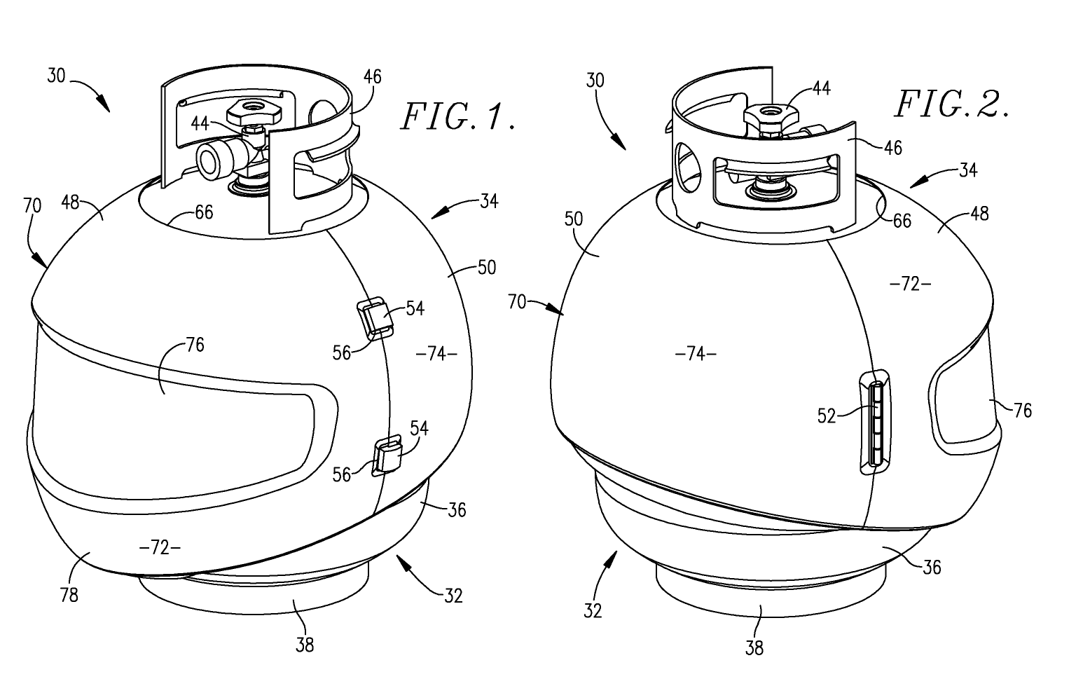

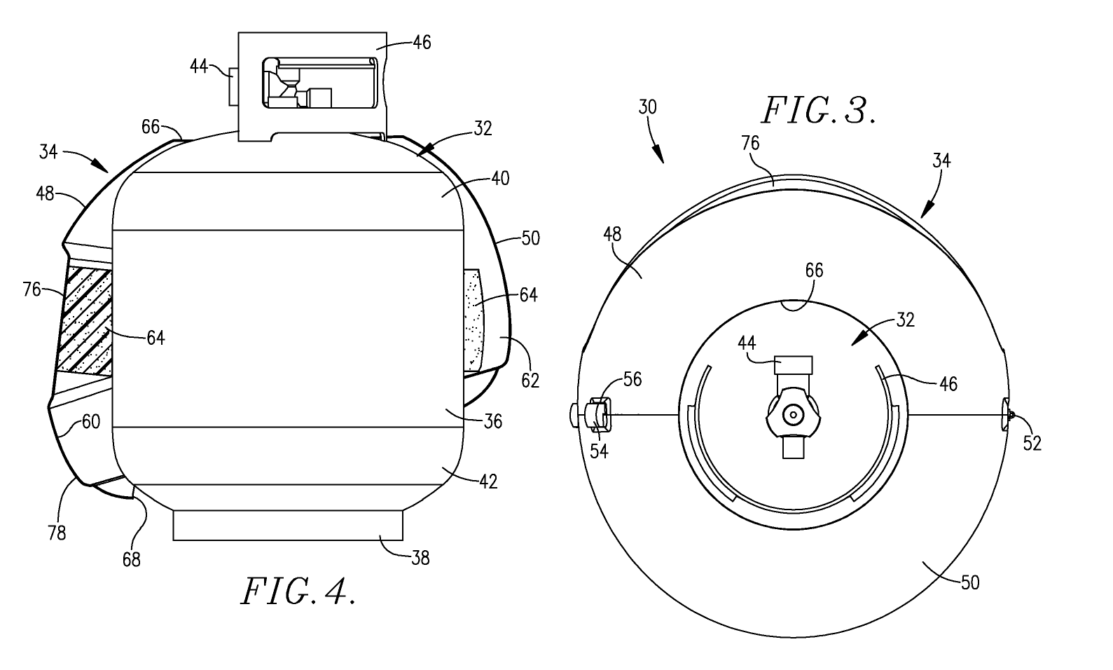

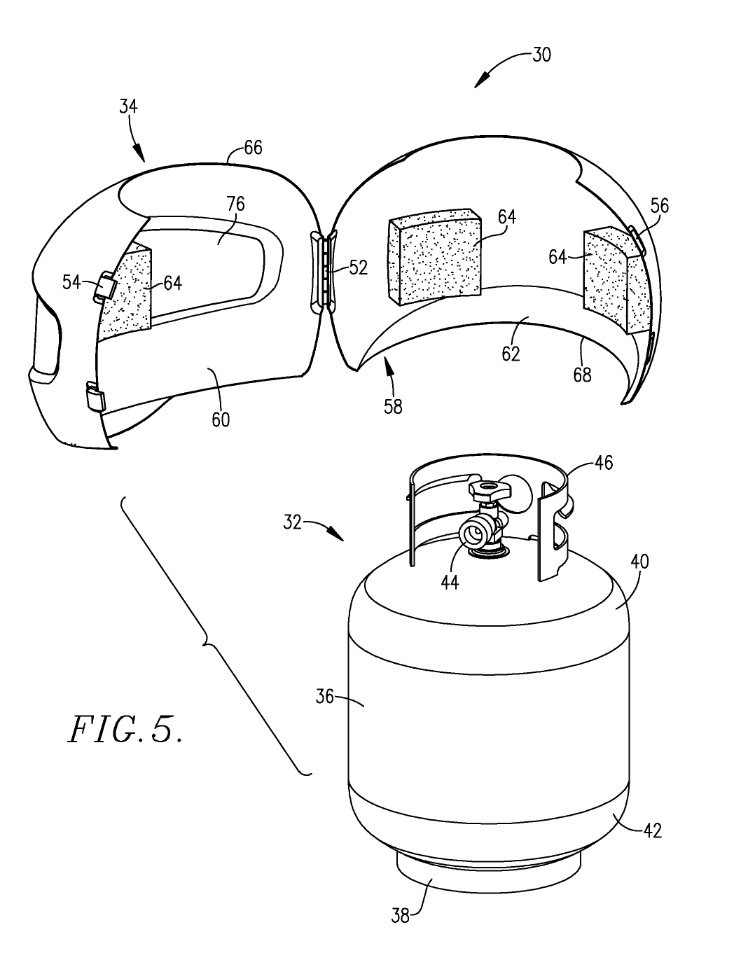

Turning now to FIGS. 1-5, a combination 30 is illustrated including a standard household propane tank 32 and a detachable, two-piece cover assembly 34. The tank 32 (see FIG. 4) includes an upright hollow propane-holding container 36 having a circular base 38 and rounded upper and lower shouldered walls 40, 42. A standard propane tank valve 44 is secured at the top of the tank and extends above the wall 40, with a carrying and connection cage 46 disposed partially about the valve 44. It will be appreciated that the tank 32 is itself wholly conventional.

The cover assembly 34 in this embodiment is made up of a rigid body preferably formed of an appropriate synthetic resin material and having front and rear sections 48 and 50 which are hingedly interconnected by means of hinge structure 52. The edges of the sections 48 and 50 opposite hinge structure 52 are provided with mating latch structures 54 and 56. As best seen in FIG. 5, the inner surface 58 of the cover assembly 34 is made up of front and rear section inner surfaces 60 and 62. These surfaces are designed to substantially surround the tank 32 and are further provided with a number of inwardly extending engagement blocks 64. As illustrated in FIG. 4, the blocks 64 are designed to firmly engage the wall of container 36 so as to prevent inadvertent axial or rotational movement of the cover assembly 34 relative to tank 32. It will further be observed that the cover assembly sections 48 and 50 cooperatively present an upper margin defining upper opening 66, which is disposed about cage 46 and valve 44, and a lower margin defining lower opening 68, which extends about the lower portion of tank 32.

In this embodiment, the outer surface 70 of the assembly 34, made up of substantially rigid front and rear walls 72 and 74, gives the three-dimensional likeness and appearance of an automobile racing helmet. Thus, the front wall 72 has a simulated visor 76 presenting concavo-convex surfaces, as well as a downwardly and outwardly extending chin section 78. In use, the cover assembly 34 is opened as depicted in FIG. 5, and closed about the tank 32 so that the latch structures 54 and 56 mate and engage. Removal of the cover assembly is accomplished by opening the latch structures and swinging the cover sections 48 and 50 apart.

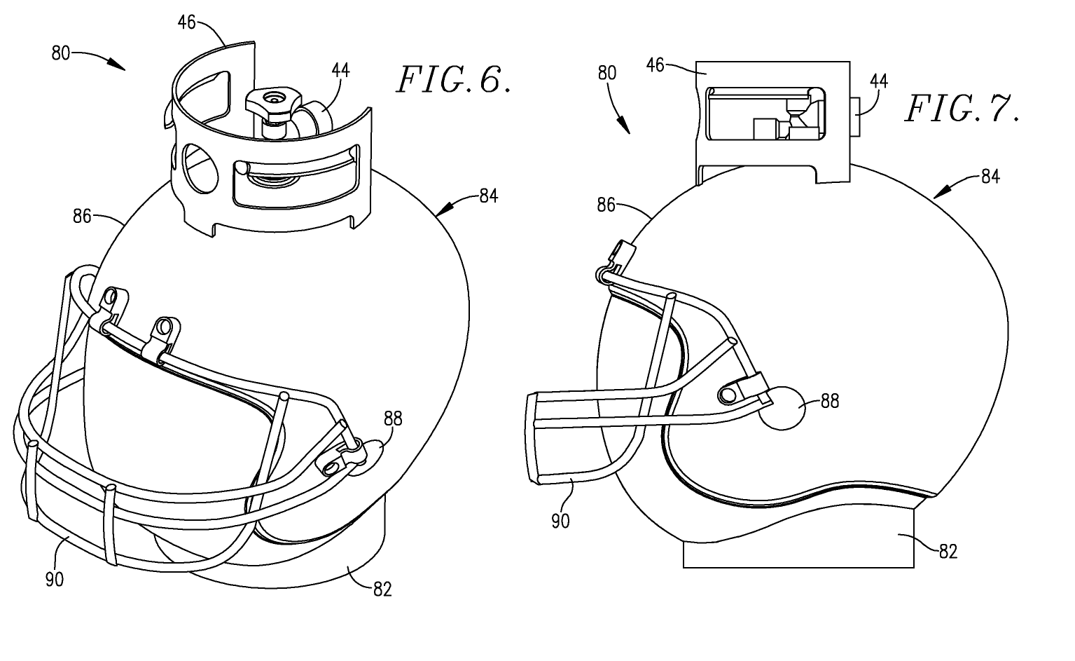

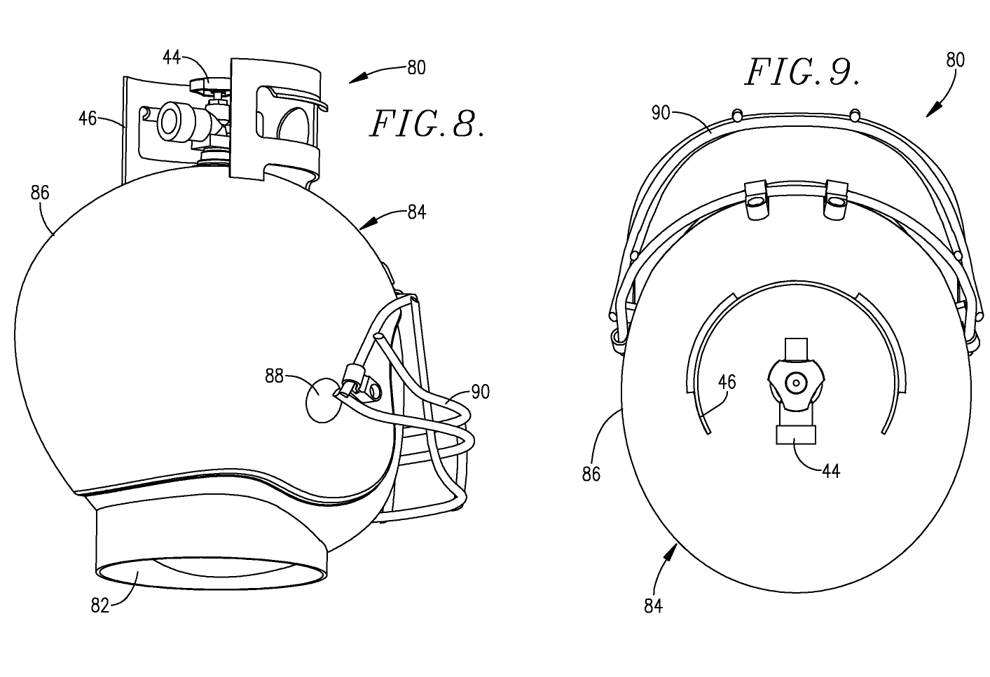

FIGS. 6-9 illustrate another embodiment in the form of a combination 80 made up of an integrated propane tank 82 and cover assembly 84. In this case, the assembly 84 has a body presenting a rigid wall defining outer surface 86, giving the three-dimensional appearance or likeness of a football helmet. The latter has a rounded surface characteristic of football helmets, along with simulated ear holes 88 and an outwardly projecting mask 90. The combination 80 further includes an upper valve 44 and cage 46, as previously described. Internally, the combination 80 may have a standard household propane tank, as described above, with the cover assembly 84 welded or otherwise permanently secured to the tank.

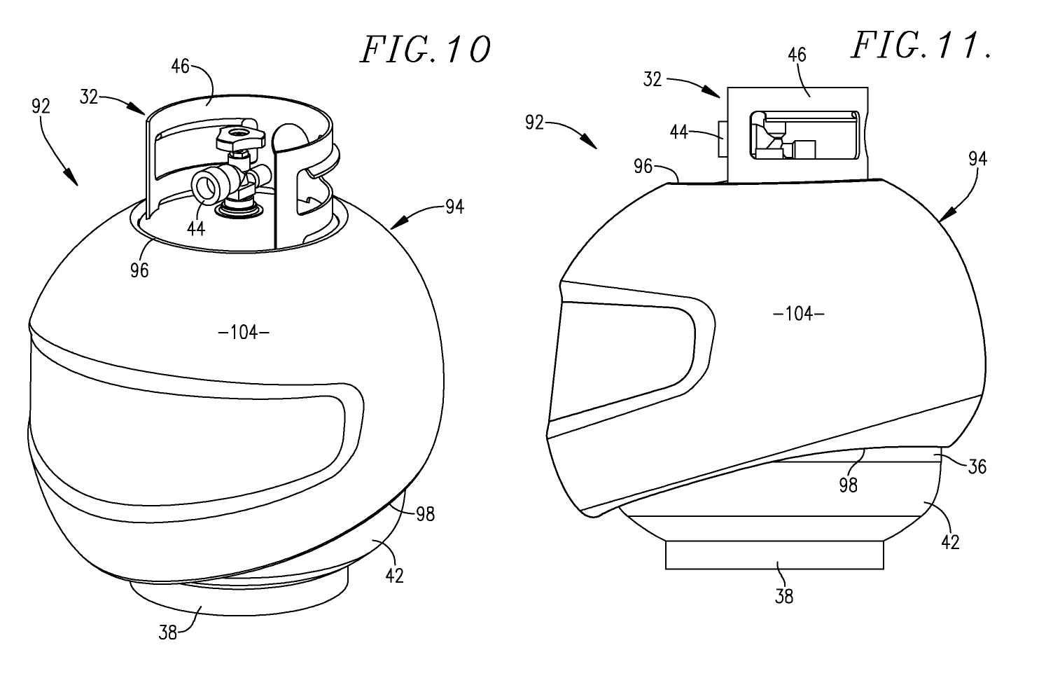

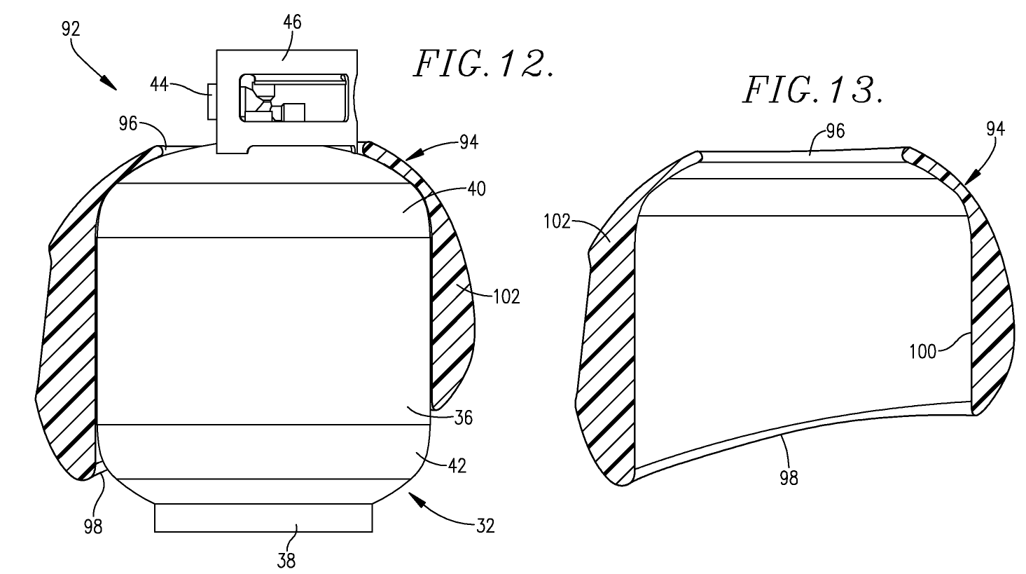

FIGS. 10-13 illustrate another form of the invention made of a combination 92 having a standard propane tank 32, described previously, and a molded, one-piece, substantially rigid, synthetic resin cover assembly 94. As best seen in FIGS. 12 and 13, the cover assembly 94 has a body presenting upper margin defining an upper opening 96 designed to surround and remain below cage 46 and valve 44, and a lower margin defining lower opening 98. The inner surface 100 of the assembly 94 is configured to closely mate with the outer wall of container 36 and shoulder 40. The assembly 94 may thus be installed on tank 32 simply by positioning the lower opening 98 above the tank and sliding the cover assembly 94 onto the tank to assume the position shown in FIG. 12. The cover can of course also be readily removed from the tank 32 by reversing this procedure. The cover assembly 94 can be fabricated from any suitable synthetic resin material, such as compressible polyurethane 102. The outer skin or surface 104 thereof is configured to give the three-dimensional likeness or appearance of an automotive racing helmet, as in the case of the first embodiment.

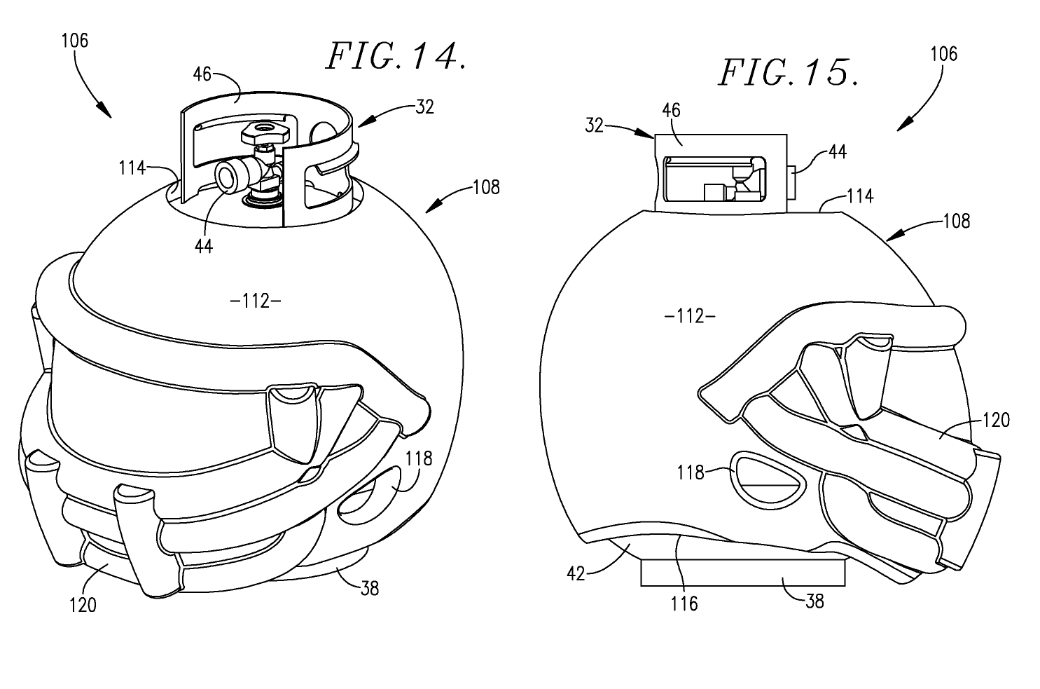

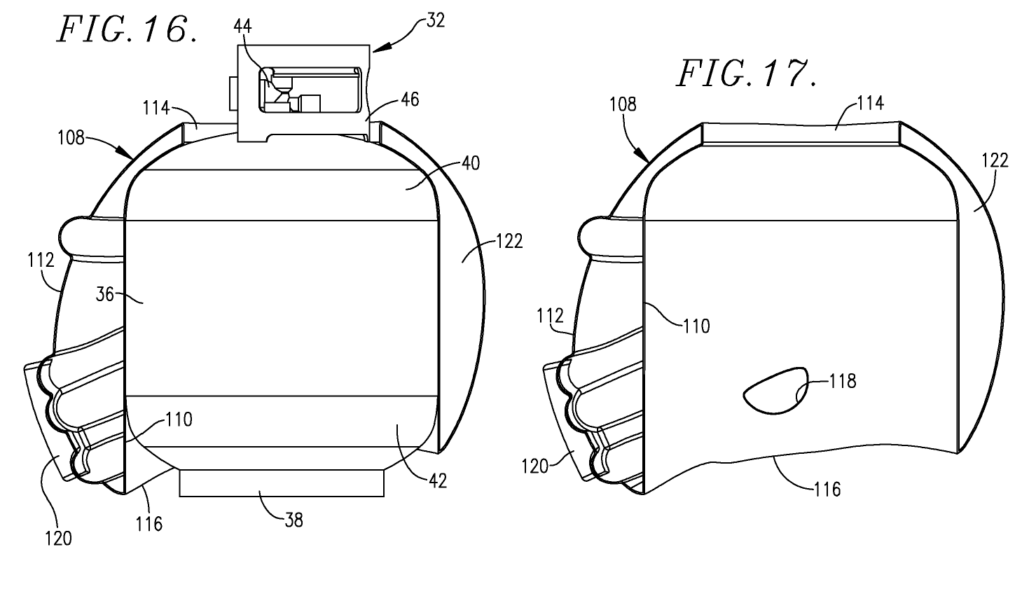

FIGS. 14-16 depict another embodiment, in the form of combination 106 again comprising a standard propane tank 32 and a cover assembly 108. The latter is in the form of a body having an inner wall 110, an outer wall 112, an upper margin defining upper opening 114, and a lower margin defining lower opening 116. Thus, the cover assembly 108 is a unitary, substantially rigid structure, similar to the cover assembly 94. The inner wall 110 is designed to closely mate with the outer surfaces of tank 32, whereas the outer wall 112 gives the three-dimensional likeness or appearance of a football helmet, including simulated ear holes 118 and an outwardly projecting face mask 120. In this instance, however, the cover assembly 108 is a substantially rigid, hollow body presenting air space 122 between the inner and outer walls 110 and 112, and can be conveniently produced by standard rotary molding or other conventional techniques. The use of assembly 108 is the same as that described with respect to unitary cover assembly 94, i.e., the cover 108 can be positioned above a tank 32 and slid into place, as shown in FIG. 16.

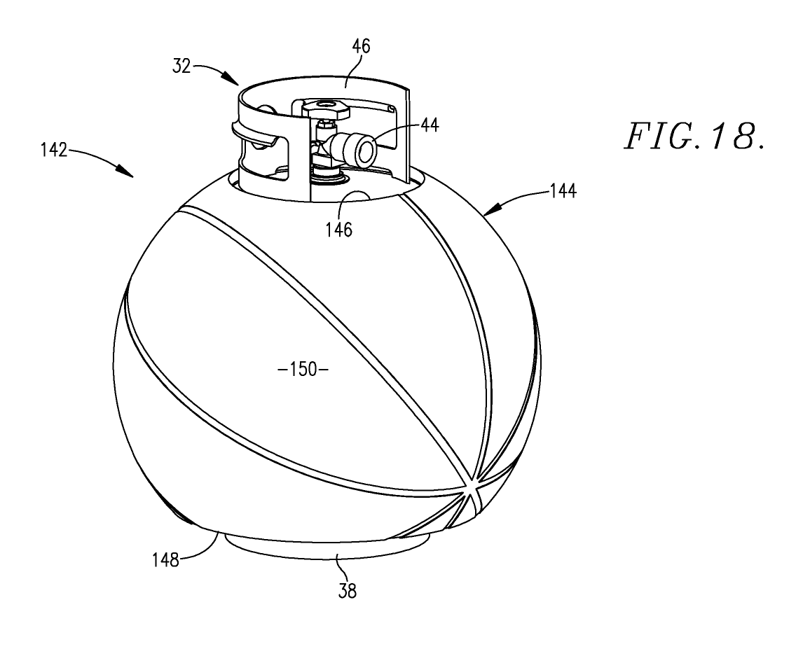

FIG. 18 illustrates a combination 142 comprising a standard propane tank 32 and a cover assembly 144. The assembly 144 has a substantially rigid body of unitary, one-piece construction as in earlier embodiments. Thus, the cover assembly 144 includes an inner surface (not shown) configured to mate with the outer surface of tank 32 and has upper and lower margins respectively defining openings 146, 148 allowing the assembly to be positioned over the tank 32. In this instance, the outer surface 150 of the assembly 144 presents the three-dimensional appearance of a basketball having simulations of typical sections and intervening seams. The cover assembly 144 may be hollow or filled.

It will thus be appreciated that the present invention provides a wide array of sports-related propane tank covers and combinations, which may be sectionalized, as illustrated in FIGS. 1-5, or unitary, as depicted in FIGS. 6-18. Alternately, combined assemblies can be made wherein the tank and cover assembly are unitized, as illustrated in FIGS. 6-9.

Furthermore, while the invention has been illustrated in the context of standard household propane tanks, the principles of the invention can be equally applied to larger or differently-configured propane tanks. Thus, the term “propane tank” as used herein should be understood to embrace all shapes and sizes of propane tanks. Additionally, the cover assemblies may be separate from or used with any size or shape of propane tank, or a propane tank may be fabricated from two or more sections by welding the sections together, wherein at least some of the sections have preformed surface design features in accordance with the invention, so that the completed tank has the likeness or appearance of a sports-related item. It will be appreciated that this form of the invention does not make use of a pre-existing or pre-formed propane tank.

As noted previously, the cover assemblies of the invention are characterized by substantially rigid outer walls configured to closely resemble a sports-related item. In many preferred forms, the entireties of the assemblies are of substantially rigid design.

1. A sports-related cover assembly for a propane tank, said tank including an upper wall and a valve extending upwardly from the upper wall, said cover assembly comprising a decorative body having wall structure configured to be placed about a propane tank and presenting an upper and a lower margin, said wall structure including a substantially rigid outer wall shaped and configured to present a three-dimensional likeness of a sports-related item, said valve extending above said cover assembly upper margin, said decorative body formed of metal, permanently secured to said tank, presenting a concavo-convex wall segment, and having a portion thereof spaced at least one-half inch from the tank.

2. (canceled)

3. The cover assembly of claim 2, said body having a pair of sections, said sections being hinged together, there being latching structure releasably interconnecting said sections when applied to a propane tank.

4. The cover assembly of claim 2, said body having an upper and a lower opening, said lower opening sized to receive a propane tank, said upper opening being smaller than said lower opening and sized to surround the valve and connection assembly of a propane tank.

5. The cover assembly of claim 2, said body formed of molded synthetic resin material.

6. The cover assembly of claim 1, the entirety of said body being substantially rigid.

7. The cover assembly of claim 1, said body being integrated with said propane tank.

8. The cover assembly of claim 1, said sports-related item selected from the group consisting of athletic headgear, athletic footwear, athletic balls, and other athletic equipment.

9. The cover assembly of claim 8, said sports-related item being athletic headgear and selected from the group consisting of helmets, caps, and hats.

10. The cover assembly of claim 9, said headgear selected from the group consisting of helmets for racing, football, lacrosse, baseball batting, rodeo, fencing, skiing and other winter sports, bicycling, hockey, and boxing.

11. The cover assembly of claim 8, said sports-related item being athletic footwear and selected from the group consisting of footwear for soccer, football, hockey, basketball, track, skiing, boxing, golf, ballet, and bicycling.

12. The cover assembly of claim 8, said sports-related item being an athletic ball and selected from the group consisting of baseballs, basketballs, cricket balls, tennis balls, footballs, rugby balls, lacrosse balls, baoding balls, billiard balls, table tennis balls, bowling balls, handballs, soccer balls, wiffle balls, polo balls, golf balls, racquet balls, beach balls, and volley balls.

13. The cover assembly of claim 8, said sports-related item being other athletic equipment and selected from the group consisting of athletic apparel selected from the group consisting of jerseys, shirts, jackets, shorts, pants, stockings, pads, and gloves, hockey pucks, curling stones, racquets, mallets, baseball bats, hockey sticks, and basketball nets.

14. (canceled)

15. A propane tank assembly comprising metal wall structure designed to contain propane and presenting an upper metal wall, there being an outer metal wall below said upper wall, a valve extending upwardly from said upper wall and above said outer wall, said outer wall below said valve being permanently secured to said upper wall, substantially rigid and shaped and configured to present a three-dimensional likeness of a sports-related item, said wall structure having a concavo-convex wall segment.

16. (canceled)

17. The assembly of claim 15, said outer wall being integrated with said wall structure.

18. The assembly of claim 15, the entirety of said outer wall being substantially rigid.

19. The assembly of claim 15, said sports-related item selected from the group consisting of athletic headgear, athletic footwear, athletic balls, and other athletic equipment.

20. The assembly of claim 19, said sports-related item being athletic headgear selected from the group consisting of helmets, caps, and hats, said helmets selected from the group consisting of helmets for racing, football, lacrosse, baseball batting, rodeo, fencing, skiing and other winter sports, bicycling, hockey, and boxing, said sports-related item being athletic footwear selected from the group consisting of footwear for soccer, football, hockey, basketball, track, skiing, boxing, golf, ballet, and bicycling, said sports-related item being an athletic ball and selected from the group consisting of baseballs, basketballs, cricket balls, tennis balls, footballs, rugby balls, lacrosse balls, baoding balls, billiard balls, table tennis balls, bowling balls, handballs, soccer balls, wiffle balls, polo balls, golf balls, racquet balls, beach balls, and volley balls, said sports-related item being other athletic equipment and selected from the group consisting of athletic apparel selected from the group consisting of jerseys, shirts, jackets, shorts, pants, stockings, pads, and gloves, hockey pucks, curling stones, racquets, mallets, baseball bats, hockey sticks, and basketball nets.

21. The assembly of claim 15, said wall structure defining said propane tank, without making use of a pre-existing propane tank.
